(19) United States
(12) Patent Application Publication
(10) Pub. No.: US 2010/0180969 A1
(43) Pub. Date: Jul. 22, 2010

(54) ELEVATIONAL ADJUSTMENT DEVICE

(76) Inventor: Jong-Jyr Kau, Taipei Hsien (TW)

Correspondence Address: Jong-Jyr Kau, 235 Chung - Ho Box 8-24, Taipei, TW

(21) Appl. No.: 12/356,523

(22) Filed: Jan. 20, 2009

(51) Int. Cl. F16K 11/07

(52) U.S. Cl. 137/625.68

(57) ABSTRACT

An elevational adjustment device comprises an object to be supported; at least one cylinder assembly located below the object to be supported for supporting the object to be supported; each of the cylinder assembly including: an inner tube surrounding the spindle; a bottom of the inner tube being installed with a valve block; the valve block having an opening; the enlarged portion at the lower end of the spindle sealing an opening of the valve block; a sub-tube surrounding the inner tube; a sleeve surrounding the sub-tube. The overall structure is divided into a first receiving chamber, a second receiving chamber and a third receiving chamber. Communication of the fluids in the receiving chambers are controlled so as to lift or descend the object to be supported.

### FIELD OF THE INVENTION

The present invention relates to elevational adjustment devices, in particular to an elevational adjustment device, in that in descending operation, the weight of the object on the device is sufficient for the operation. In lifting, only a slight force is used.

### BACKGROUND OF THE INVENTION

In our daily life, many objects, such chairs, desks, cabinets, medical beds, exercises devices, working platforms, etc. are needed to be adjusted in elevation due to the using habits or power saving or comfort feeling. In the prior art, telescopic tubes are used, which has a main tube and a sub-tube. The tubes are retained by screws.

Currently, pressure cylinder assemblies are sued to adjustment of the elevations. Fluids, such as gas or oil, are filled therein so as to provide different rigidity or elasticity.

In one prior art used for chairs, a buckle and a valve block are provided for adjusting the fluid in the cylinder assembly by opening or closing of the valve block. Weight from user will press the cylinder assembly to reduce. However this simple prior structure is only suitable for chairs because it uses the weight of the user who seats upon the chair. Furthermore, its precision is low and thus is not suitable for using in reading desks, eating desks, work platforms, operation platforms, medical chairs, and other devices which are difficult for the operation by patients. Thus, the usage of the prior art structure is limited.

### SUMMARY OF THE INVENTION

According, the present invention provides an elevational adjustment device, comprising: an object to be supported; at least one cylinder assembly located below the object to be supported for supporting the object to be supported; each of the cylinder assembly including: a spindle, a lower end of the spindle being enlarged as an enlarged portion; an inner tube surrounding the spindle; a buckle; a frame supporting the buckle and being installed at a top of the inner tube; the frame being combined to the object to be supported so that the object to be supported is combined to the cylinder assembly and compresses the inner tube; a bottom of the inner tube being installed with a valve block; the valve block having an opening; the enlarged portion at the lower end of the spindle sealing an opening of the valve block; downward movement of the spindle will push the enlarged portion to be out of an opening; a lower end of the inner tube is installed with a limiting flange; a through hole being formed on the limiting flange; the limiting flange serving to isolate an inner space of the inner tube; the through hole being communicated to the opening; a lower side of the inner tube being installed with a check valve; opening and closing of the check valve being controlled by the enlarged portion of the spindle; a sub-tube surrounding the inner tube; the limiting flange tightly resisting against an inner side of the sub-tube; an upper side of the inner side of the sub-tube above the limiting flange being formed with a first receiving chamber; a lower side of the inner side of the sub-tube below the limiting flange being formed as a second receiving chamber which is communicated to the first receiving chamber as the opening is opened; and a sleeve surrounding the sub-tube; a space between the sleeve and the sub-tube being formed as a third receiving chamber; fluid flows between the first receiving chamber and the second receiving chamber; the second receiving chamber and third receiving chamber have fluids, respectively; communication of the fluids in the second receiving chamber and third receiving chamber are controlled by the check valve.

When it is desired to lift the object to be supported, it is only necessary that the user's hand to support the object to be supported so that the weight to the cylinder assembly is reduced so that the object 1 to be supported can be lifted upwards. When it is desired to slightly descend the object to be supported, it is only necessary to slightly press the buckle so that the spindle will drive the valve block to align the opening and the through hole and then actuate the check valve. Thus, the object to be supported descends until it is released to actuate the buckle. Then the object to be supported stops.

Even the user do not apply any force thereto, since the weight of the object to be supported is X, when no fluid flows, the object to be supported will be fixed at a predetermined height in an equilibrium state. Therefore, the present invention can be applied to an object to be supported which is not pressed normally. Other than chairs, the present invention can be widely used in desks (such as reading desks, office desks, etc.), or patient beds, or cabinets. Only one hand is necessary in operation. The present invention is especially suitable for the beds or devices which need to be lifted or descends in adjustment.

Therefore, the present invention is used to the object which is not necessary to be supported normally. The ratio of gas and oil in the cylinder assembly can be adjusted as desired so as to provide a feeling as a shockproof device of a car. As comparing with other adjusting devices, the present invention is stable and reliable. Furthermore, it can be operated by single hand without the help of other people. The present invention can be widely used to tables, reading desks, eating desks, office desks, patient beds, cabinets, wine cabinets, book cabinets.

The various objects and advantages of the present invention will be more readily understood from the following detailed description when read in conjunction with the appended drawing.

### BRIEF DESCRIPTION OF THE DRAWINGS

FIG. 1 is a schematic view showing the use of the present invention.

FIG. 2 is an exploded perspective view of the present invention.

FIG. 3 is a schematic view showing the flowing state of the present invention.

FIG. 4 is a further schematic view showing the flowing state of the present invention.

FIG. 5 is a perspective view showing that the cylinder assembly of the present invention is at a whole assembled state.

FIG. 6 is a schematic view showing the buckle and frame of the present invention.

FIG. 7 is a perspective view showing the expansion state of the cylinder assembly according to the present invention.

FIG. 8 is a schematic view showing that the present invention is applied to a desk.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

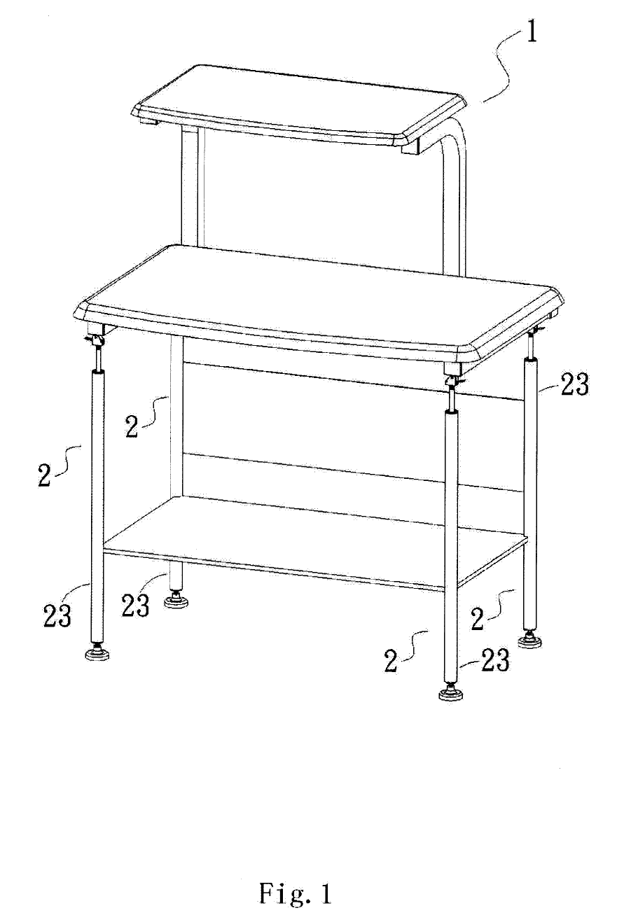

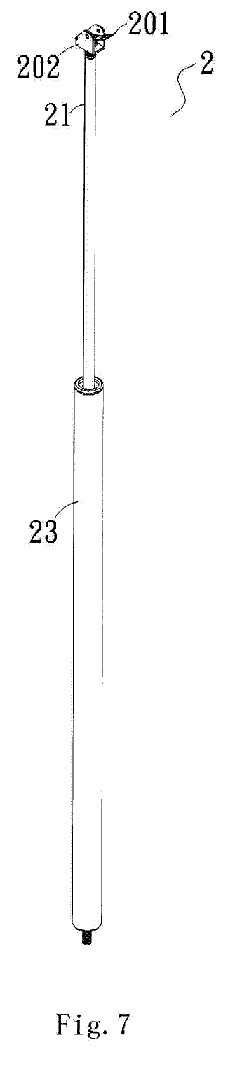

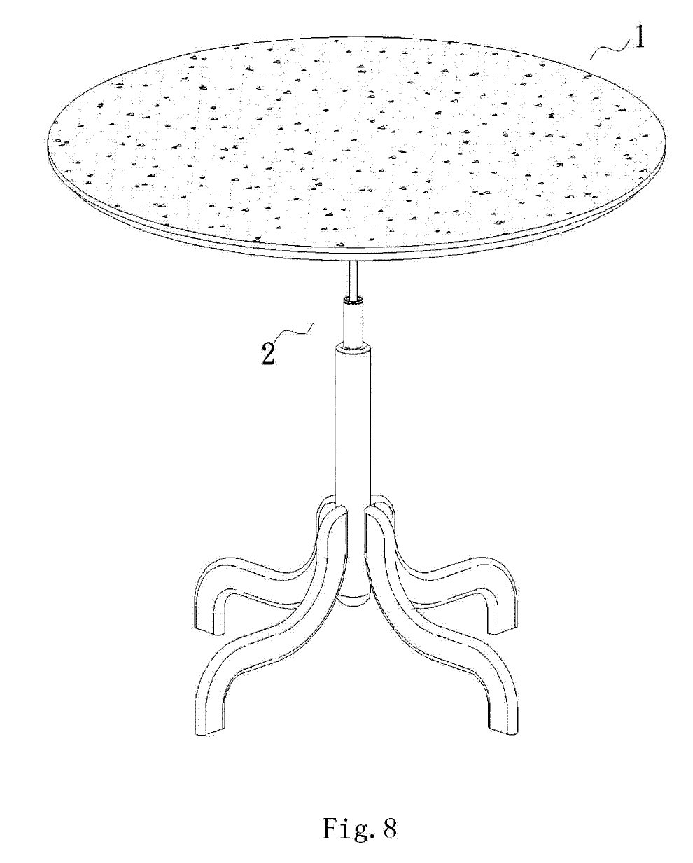

Referring to FIGS. 1 to 8, an elevation adjusting device for an object 1 to be supported according to the present invention is illustrated. The present invention includes the following structure.

An object 1 to be supported has a weight of X. The object 1 to be supported may be a table, such as a reading desk, an eating desk, an office desk, and others, or a patient bed, a cabinet (such as a wine cabinet, a book cabinet, etc.) which are difficult to be carried by peoples.

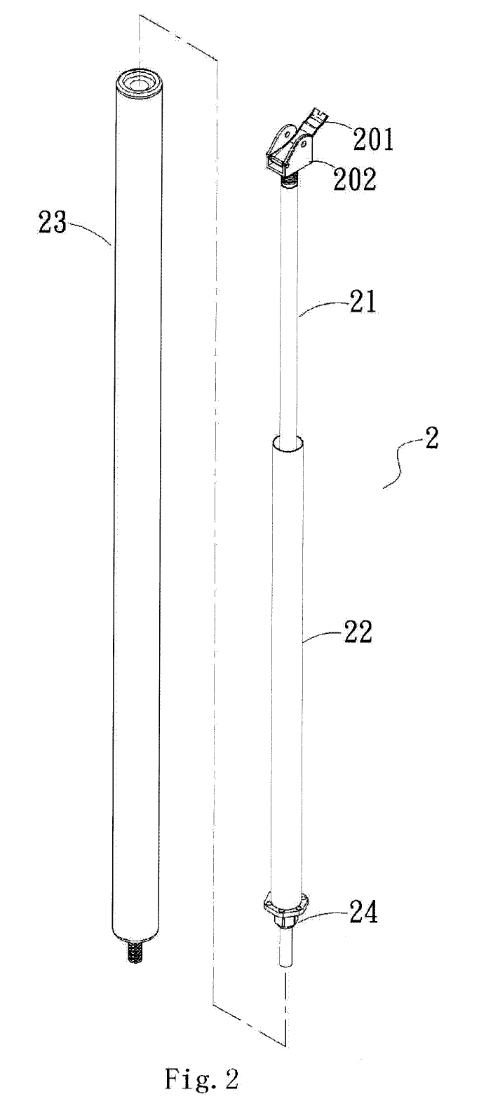

Four cylinder assembly 2 are located below the object 1 to be supported. With referring to FIG. 2 to 4, each of the cylinder assembly 2 has the following elements.

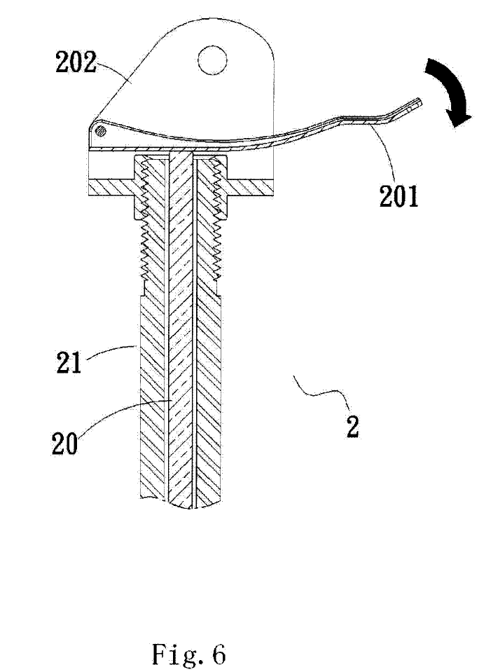

A spindle 20 has a buckle 201 at a topside thereof. The buckle 201 is installed upon a frame 202 (referring to FIG. 6). A lower end of the spindle 20 is enlarged.

An inner tube 21 surrounds the spindle 20. The frame 202 is installed at a top of the inner tube 21. The frame 202 is combined to the object 1 to be supported so that the object 1 is combined to the cylinder assembly 2 and compresses the inner tube 21. A bottom of the inner tube 21 is installed with a valve block 203. The valve block 203 has an opening 212. The enlarged portion at the lower end of the spindle 20 normally seals the opening 212 of the valve block 203. Downward movement of the spindle 20 will push the enlarged portion to be out of an opening 212. A lower end of the inner tube 21 is installed with a limiting flange 211. A through hole 213 is formed on the limiting flange 211. The limiting flange 211 serves to isolate an inner space of the inner tube 21. The limiting flange 211 may be made of flexible washer. The through hole 213 is communicated to the opening 212. A lower side of the inner tube 21 is installed with a check valve 24. The opening and closing of the check valve 24 is controlled by the enlarged portion of the spindle 20 through an interaction mechanism or by using negative pressure. For example the enlarged portion of the spindle 20 can push the check valve to be opened, or the pressure from the fluid in the inner tube 21 will push the check valve 24 to be opened.

A sub-tube 22 surrounds the inner tube 21. The limiting flange 211 tightly resists against an inner side of the sub-tube 22. The inner space of the sub-tube 22 above the limiting flange 211 is formed as a first receiving chamber A. The inner space of the sub-tube 22 below the limiting flange 211 is formed as a second receiving chamber B which is communicated to the first receiving chamber A as the opening 212 is opened.

A sleeve 23 surrounds the sub-tube 22. A space between the sleeve 23 and the sub-tube 22 is formed as a third receiving chamber C. Fluid flows between the first receiving chamber A and the second receiving chamber B. The second receiving chamber B and third receiving chamber C have fluids, respectively. The communication of the fluids in the second receiving chamber B and third receiving chamber C are controlled by the check valve 24. The opening and closing of the check valve 24 is controlled by the valve block 203.

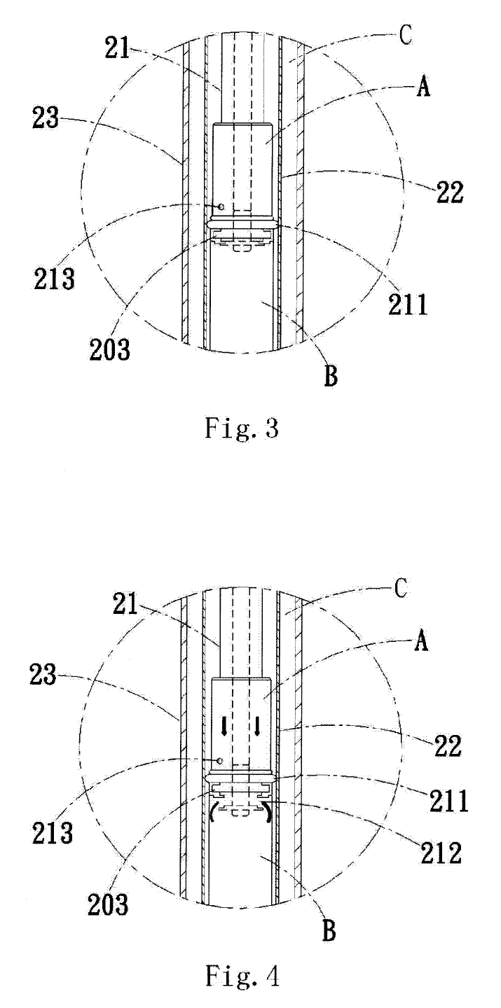

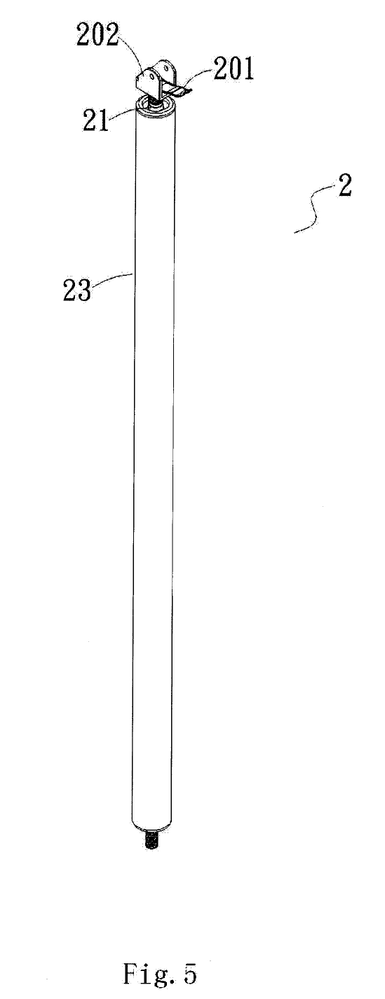

With referring to FIGS. 3 and 4, fluid in the first receiving chamber A and second receiving chamber B are communicated by the compression of the object 1 to be supported.

Furthermore, a lower side of the inner tube 21 is installed with a check valve 24 which is opened or closed by the action of the valve block 203 so that the fluids in the third receiving chamber C and second receiving chamber B are communicated.

Therefore, when it is desired to lift the object 1 to be supported, it is only necessary that the user's hand to support the object 1 to be supported so that the weight to the cylinder assembly 2 is reduced. Since the fluids in the first receiving chamber A and second receiving chamber B are communicable, and the check valve 24 can isolate the third receiving chamber C. When the third receiving chamber C is isolated, the fluid in the first receiving chamber A and the second receiving chamber B can only support a weight smaller than the weight of the object 1 to be supported (X) so that the object 1 to be supported can be lifted upwards.

When it is desired to slightly descend the object 1 to be supported, it is only necessary to slightly press the buckle 201 so that the spindle 20 will drive the valve block 203 to align the opening 212 and the through hole 213 and then actuate the check valve 24. Thereby the flow paths are communicated. Since the weight of the object 1 to be supported will press the fluid to flow downwards. Thus, the object 1 to be supported descends until it is released to actuate the buckle 201. Then the object 1 to be supported stops.

Even the user do not apply any force thereto, since the weight of the object 1 to be supported is X, when no fluid flows, the object 1 to be supported will be fixed at a predetermined height in an equilibrium state. Therefore, the present invention can be applied to an object 1 which is not pressed normally. Other than chairs, the present invention can be widely used in desks (such as reading desks, office desks, etc.), or patient beds, or cabinets. Only one hand is necessary in operation. The present invention is especially suitable for the beds or devices which need to be lifted or descends in adjustment.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An elevational adjustment device, comprising:
an object to be supported;
at least one cylinder assembly located below the object to be supported for supporting thereto; each of the cylinder assembly including:
a spindle; a lower end of the spindle being enlarged as an enlarged portion;
an inner tube surrounding the spindle; a buckle; a frame supporting the buckle and being installed at a top of the inner tube; the frame being combined to the object to be supported so that the object is combined to the cylinder assembly and compresses the inner tube; a bottom of the inner tube being installed with a valve block; the valve block having an opening; the enlarged portion at the lower end of the spindle sealing an opening of the valve block; downward movement of the spindle will push the enlarged portion to be out of an opening; a lower end of the inner tube is installed with a limiting flange; a through hole being formed on the limiting flange; the limiting flange serving to isolate an inner space of the inner tube; the through hole being communicated to the opening; a lower side of the inner tube being installed with a check valve; opening and closing of the check valve being controlled by the enlarged portion of the spindle;
a sub-tube surrounding the inner tube; the limiting flange tightly resisting against an inner side of the sub-tube; an upper side of the inner side of the sub-tube above the limiting flange being formed as a first receiving chamber; a lower side of the inner side of the sub-tube below the limiting flange being formed as a second receiving chamber which is communicated to the first receiving chamber as the opening is opened; and
a sleeve surrounding the sub-tube; a space between the sleeve and the sub-tube being formed as a third receiving chamber; fluid flows between the first receiving chamber and the second receiving chamber; the second receiving chamber and third receiving chamber have fluids, respectively; communication of the fluids in the second receiving chamber and third receiving chamber are controlled by the check valve.

2. The elevational adjustment device as claimed in claim 1, wherein the object to be supported is one of a table, a reading desk, an eating desk, an office desk, a patient bed, an cabinet, a wine cabinet, and a book cabinet.

3. The elevational adjustment device as claimed in claim 1, wherein the limiting flange is a flexible washer.

4. The elevational adjustment device as claimed in claim 1, wherein a buckle is installed at a top of the spindle; and the buckle is installed upon a frame for supporting the buckle.

5. The elevational adjustment device as claimed in claim 4, wherein the frame being installed at a top of the inner tube; the frame is combined to the object to be supported so that the object to be supported is combined to the cylinder assembly and compresses the inner tube.

6. The elevational adjustment device as claimed in claim 1, wherein fluids within the first receiving chamber, second receiving chamber and third receiving chamber are selected from gas, oil and mixture of gas and oil.
